(19) United States
(12) Patent Application Publication
(10) Pub. No.: US 2025/0354328 A1
(43) Pub. Date: Nov. 20, 2025

(54) BIOTEXTILE AND PLANT-BASED FEEDSTOCK MATERIAL COMPRISING A PARTIALLY OR FULLY BIODEGRADABLE COMPOSITE, AND METHODS OF MAKING THE COMPOSITE

(71) Applicant: RHEOM MATERIALS INC., Houston, TX (US)

(72) Inventors: Alexander J. KALIN, Houston, TX (US); Carolina AMIN FERRIL, Kingwood, TX (US); Zimri T. HINSHAW, Houston, TX (US); Sanjay KALRA, Jericho, NY (US); Amanda TSAI, Baton Rouge, LA (US)

(21) Appl. No.: 18/867,691

(22) PCT Filed: May 22, 2023
(86) PCT No.: PCT/US2023/023109

§ 371 Date: Nov. 20, 2024

Related U.S. Application Data
(60) Provisional application No. 63/345,118, filed on May 24, 2022.

(51) Int. Cl. D06N 3/02; B33Y 70/00; D06N 3/12

(52) U.S. Cl. CPC D06N 3/02; B33Y 70/00; D06N 3/12; D06N 2203/028; D10B 2201/01

(57) ABSTRACT

A biotextile for a plant-based leather product comprises a partially or fully biodegradable composite including: a polymer matrix comprising a bio-based polymer, and a cellulosic material dispersed in the polymer matrix. At least one property of the composite is sufficient to meet an industrial standard for leather or vinyl. A method of making the composite may include heating and mixing a formulation comprising bio-based polymer, a plasticizer, and a cellulosic material to form a molten mixture, extruding the molten mixture to form an extruded body having a predetermined shape, and cooling the extruded body to form a composite having the predetermined shape, which may be a sheet, rod, pellet, or granule. The composite includes a polymer matrix comprising the bio-based polymer with the cellulosic material dispersed therein. A plant-based feedstock material comprising the composite may be used as a raw material for injection molding or 3D printing.

### RELATED APPLICATION

The present patent document claims the benefit of priority under 35 U.S.C. 119(e) to U.S. Provisional Patent Application No. 63/345,118, which was filed on May 24, 2022, and is hereby incorporated by reference in its entirety.

### TECHNICAL FIELD

The present disclosure is related generally to bio-based materials and more specifically to a biotextile and a plant-based feedstock material comprising a partially or fully biodegradable polymer composite.

### BACKGROUND

The motivation for sustainable plant-based leather alternatives comes from the desire to avoid animal cruelty, and the need to limit the harmful effects of animal leather production from land usage and greenhouse gas emission on the environment. Additionally, most of the tanning processes used to prepare natural leather use toxic chemicals that can be released into the environment and slow leather's degradation time to up to 50 years. Plastic-based leather made from plastics like polyurethane (PU), and polyvinyl chloride (PVC) are common leather alternatives. While these plastics are animal-free, they are still harmful to the environment, as they can release toxic chemicals before, during, and after their product's lifespan. Converting fossil fuels into plastic can pollute the air and water in the ecosystem, and these petrochemical plastics are not biodegradable; they may require over 500 years to biodegrade, causing a buildup of plastic in landfills.

Leather and other fabrics are also traditionally dyed in a dye bath that includes synthetic dyes. These baths require significant water usage and are often dumped into the natural bodies of water or the water supply, causing both water pollution and, later, soil contamination issues. This pollution can result in harm to the environment, people, and the global food supply. Additionally, the creation of petroleum-based synthetic dyes emits large quantities of carbon, which can further harm the ecosystem.

An eco-friendly leather alternative would find application in numerous applications and avoid the above-described shortcomings of animal-based leather and petrochemical-based leather alternatives.

### BRIEF DESCRIPTION OF THE DRAWINGS

FIG. 1 is a schematic of a biotextile comprising a partially or fully biodegradable composite.

FIG. 2 is a schematic of the biotextile of FIG. 1 incorporated into exemplary plant-based leather products.

FIG. 3 is a schematic of a plant-based feedstock material (e.g., one or more rods, pellets, and/or granules) comprising a partially or fully biodegradable composite that may be delivered into a printhead, hopper or mold to fabricate a molded or 3D printed part.

FIG. 4 is a simple flow chart of methods of forming the partially or fully biodegradable composite, which may be used as a biotextile or as a plant-based feedstock material for molding or 3D printing.

### DETAILED DESCRIPTION

Described herein is a sustainable leather textile that is animal-free, primarily or exclusively bio-based, and partially or fully biodegradable. Implementation of the plant-based leather textile or “biotextile” as a replacement for animal-based and petrochemical-based leathers may significantly reduce environmental issues, such as deforestation, air pollution, toxic chemical release, and landfill waste. In some examples, the biotextile may be translucent and thus may be referred to as a sustainable translucent textile, which may be used in place of leather, plastic, and/or vinyl in applications where a translucent design aesthetic is desired. Also described in this disclosure are plant-based leather products including the biotextile, and methods of fabricating the biotextile. Additionally, the composite may serve as a plant-based feedstock material for injection molding, 3D printing, or another materials processing method.

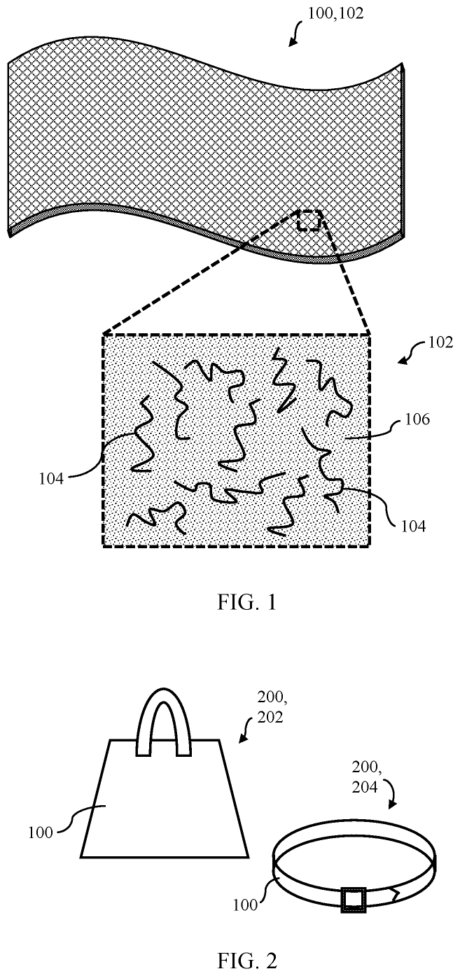

The inventive biotextile 100 comprises a partially or fully biodegradable composite 102 that utilizes a cellulosic material such as bacterial cellulose (also referred to as bacterial nanocellulose) 104 as a reinforcement or filler material in a polymer matrix 106, as shown schematically in FIG. 1. The cellulosic material 104 is preferably well dispersed in the polymer matrix 106, which includes a bio-based polymer, such as starch. As used herein, the term bio-based polymer may refer to a natural polymer, such as starch, a synthetic polymer obtained partly or fully from renewable raw materials (e.g., plants, algae, or microorganisms), and/or a fermented polymer, such as polyhydroxyalkanoate (PHA). Examples of suitable synthetic polymers may include polyethylene (PE) or low-density polyethylene (LDPE), poly(butylene succinate) (PBS), polyethylene terephthalate (PET), polylactic acid (PLA), poly(ethylene furanoate) (PEF), and/or polyvinyl alcohol (PVA). It is understood that a composite 102 described as being partially or fully biodegradable may decompose in full or in part over time through the action of microorganisms under suitable environmental conditions.

At least one property of the partially or fully biodegradable composite 102—e.g., durability, water resistance, tensile strength, tear resistance, heat/cold resistance, flex resistance, water vapor permeability, water resistance, ultraviolet (UV) radiation resistance, and/or abrasion resistance—is sufficient to meet or exceed an industrial standard for leather or vinyl. Advantageously, the biotextile 100 exhibits multiple properties that meet or exceed the applicable industrial standard for leather or vinyl. The industrial standards may include ISO 20942, ISO 17186, ISO 32100, ISO 14268, ISO 12947, and/or AATCC 16. In some examples, the biotextile 100 may be translucent. For example, the biotextile 100 may have a translucency comparable to or higher than that of polyurethane (PU) and/or thermoplastic polyurethane (TPU).

As indicated above, the polymer matrix 106 comprises a bio-based polymer. In one example, the bio-based polymer comprises starch, which is a natural polymer, and more specifically a polymeric carbohydrate or polysaccharide, that is both renewable and widely available. Since starch tends to be brittle with poor mechanical properties, the biodegradable composite 102 may advantageously be prepared from a formulation that includes one or more plasticizers, as discussed below, along with the cellulose reinforcements 104, and optionally other additives. Starch that has been blended with one or more plasticizers and optionally one or more additional polymers, which may be bio-based polymers, may be referred to as thermoplastic starch (TPS) due to its ability to flow at elevated temperatures (e.g., for extrusion-based processing). In some examples, the polymer matrix 106 undergoes crosslinking during fabrication to impart additional strength to the biotextile 100. Preferably, the polymer matrix 106 includes only natural polymers, although in some examples, additions of synthetic polymers, such as polyvinyl alcohol (PVA), a water-soluble synthetic polymer, may be appropriate. The PVA may form part of the polymer matrix and may also act as a plasticizer during preparation of the biodegradable composite. Natural polymers such as starch are excellent candidates for biotextile applications due to their ability to biodegrade. PVA is also biodegradable. As indicated above, the polymer matrix may include one or more synthetic polymers derived in whole or in part from renewable materials and/or one or more fermented polymers.

The use of bacterial cellulose or another cellulosic material 104 as a reinforcement or filler material in the polymer matrix 106 may impart desirable mechanical properties to the biotextile 100, such as high tensile strength and resistance to compressive and shear forces. The cellulosic material 104 may be derived from bacteria (in the example of bacterial cellulose), or another source, such as plants, trees or algae. In some examples, bacterial cellulose may be used in combination with cellulosic material(s) derived from other sources as the reinforcement or filler material. The cellulosic material 104 may take the form of crystalline cellulose (e.g., cellulose nanocrystals, microcrystalline cellulose), cellulose nanofibrils, micro fibrillated cellulose, and/or sodium carboxymethyl cellulose (CMC). Bacterial cellulose 104 may have nanofibrillar structure or a particulate structure (powder), e.g., following milling. In some examples, the bacterial cellulose 104 may include carboxymethylcellulose (CMC) on surfaces thereof. CMC has a negative charge that can redistribute itself on the bacterial cellulose fibrils or fibers. These charges can provide repulsion capabilities that prevent bacterial cellulose fibers 104 from relaxing their formed network, providing improved stabilization and dispersion. Typically, the bacterial cellulose or other cellulosic material 104 is dispersed in the composite 102 at a concentration in a range from about 1 wt. % to about 20 wt. %, and/or from about 10 wt. % to about 15 wt. %. A suitable level of reinforcement and good dispersion may result in a robust composite 102 that performs better than cellulose (e.g., bacterial cellulose) sheets alone. The composite structure of the biotextile 100 enables the use of further additives (e.g., crosslinkers, hydrophobic agents, etc., as discussed below) to alter the textile properties, such as stiffness, strength, and hydrophobicity, which cannot be done with dry cellulose sheets. Typically, the composite 102 has a thickness in a range from about 0.5 mm to about 4 mm, or from about 1 mm to about 2 mm, based on the intended applications.

The biotextile 100 described herein may form part or all of a plant-based leather product 200, as illustrated in FIG. 2, such as a purse 202, bag, wallet, shoe, belt 204, strap, handle, watch band, apparel item (e.g., jacket, glove, pants), dashboard, automotive interior coverings, automotive safety gear, aerospace textile, bicycle seat textile, upholstery, interior design item (e.g., lampshade, pillows, electrical fixture covers), home goods item (e.g., tea kettle handle, headphone cushion covering), boxing glove, weight training belt, upholstery, pet collar, bath sandal, brush, book binding, book cover, exercise equipment, portable electronics cases or covers, protective coating and/or other products traditionally made from animal-based leather or vinyl.

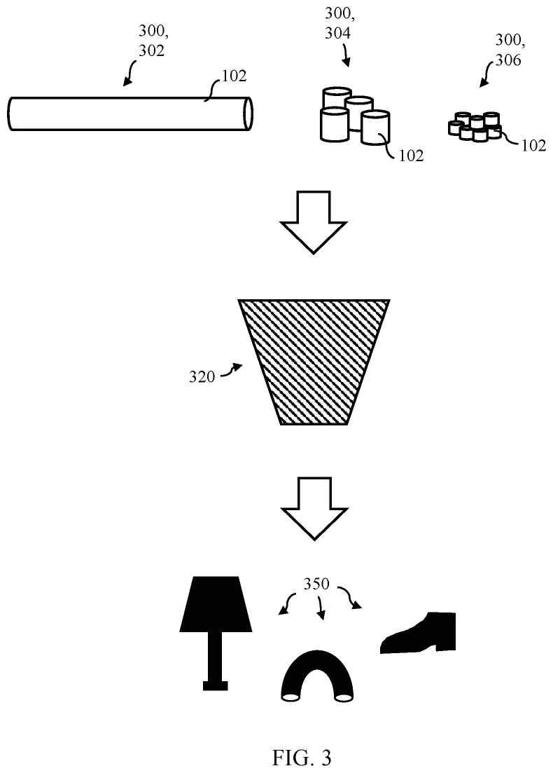

The partially or fully biodegradable composite 102 may be prepared from a formulation including a bio-based polymer such as starch, a plasticizer, and a cellulosic material such as bacterial cellulose 104. The formulation may undergo solution/solvent processing or melt processing (e.g., melt extrusion), as discussed in greater detail below, in order to fabricate a biotextile 100 or a plant-based feedstock material having a particular form factor (e.g., size and shape). For example, the biotextile 100 may be fabricated in the form of a sheet. Referring to FIG. 3, the plant-based feedstock material 300, which is further described below, may be used as a raw material for molding (e.g., injection molding) or 3D printing, and thus may be fabricated in the form of one or more rods 302, pellets 304, or granules 306. In some examples, the formulation may include water as a solvent, and in other examples the formulation may not include (added) water and may instead be melted for processing.

Starch, which may be used alone or in combination with another bio-based polymer to form the polymer matrix 106 of the composite 102, may be derived from any of several natural sources, such as cassava root, arrowroot, wheat, potatoes, corn, and/or rice. In some examples, starch may be blended with one or more plasticizers and/or one or more additional polymers, such as a polyester, to become plasticized, that is, to take the form of thermoplastic starch. As described in the examples below, thermoplastic starch may be blended with one or more other bio-based polymers, such as polyhydroxylalkanoate and/or poly(butylene succinate), to further improve processability and/or properties of the resulting composite 102. In other examples, starch may not be employed in the formulation to form the polymer matrix 106 and instead one or more other bio-based polymers, e.g., other thermoplastic bio-based polymers, may be used. For example, a bio-based low-density polyethylene may be employed in lieu of starch, possibly in combination with polyhydroxylalkanoate and/or poly(butylene succinate), as described in the examples below. It may be beneficial to combine a bio-based polymer having good rigidity and strength with another bio-based polymer having good flexibility and ductility, for example. Blending ratios (by weight) of two bio-based polymer resins (e.g., a primary polymer resin and a secondary polymer resin) employed for the formulation may range from about 90:10 to about 50:50. As known to one of ordinary skill in the art, the bio-based polymer(s) that form the polymer matrix 106 may be included in the formulation in the form of bio-based polymer resin(s). Given this understanding, the term “polymer” and “polymer resin” may be used interchangeably when discussing constituents of the formulations. In terms of total concentration in the formulation, the starch and/or other bio-based polymer(s) may be included at a concentration in a range from about 40 wt. % to about 80 wt. %.

Typically, the cellulosic material 104 has a concentration in the formulation in a range from about 1 wt. % to about 20 wt. %, and/or from about 10 wt. % to about 15 wt. %. As indicated above, the bacterial cellulose or other cellulosic material 104 may have a nanofibrillar structure and thus may alternatively be referred to as cellulose fibers or as bacterial cellulose fibers 104. The bacterial cellulose 104 may be obtained from commercial sources or grown in-house in the form of symbiotic culture of bacteria and yeast (SCOBY). In some examples, commercially available slurries including bacterial cellulose and a plasticizer such as glycerol dispersed in water may be suitable to prepare the formulation.

The addition of bacterial cellulose or another cellulosic material to the formulation, which may include starch and, in some examples, another bio-polymer such as PVA, may increase the amount of strong hydrogen bonding within the polymer matrix, thereby limiting the mobility of the polymer chains. This reduction in polymer chain mobility may provide excellent tensile strength in the resulting composite. If properly dispersed, the bacterial cellulose fibers may form hydrogen bonds with the polymer matrix and decrease the number of free OH-groups. This may have the added benefit of increasing the water-resistance of the biotextile 100.

The plasticizer may comprise glycerin (glycerol), sorbitol, sorbitan, propylene glycol, and/or other sugar alcohols, such as maltitol. When the polymer matrix 106 of the partially or fully biodegradable composite 102 includes PVA, the PVA may function both as a matrix component and as a plasticizer. The plasticizer may be included in the formulation at a concentration in a range from about 5 wt. % to about 50 wt. %, from about 5 wt. % to about 25 wt. %, and/or from about 25 wt. % to about 50 wt. %. For example, if PVA is employed as a plasticizer (and matrix component), the concentration of PVA may lie in the range from about 25 wt. % to about 50 wt. %. If glycerol, sorbitol, sorbitan, propylene glycol, and/or sugar alcohol (e.g., maltitol) is/are employed as the plasticizer, then the concentration of each may lie in the range from about 5 wt. % to about 25 wt. %. The plasticizer improves polymer chain flexibility, which can increase the ductility of the biotextile 100. Glycerol, for example, may also be used to reduce the water permeability of the biotextile 100. However, too high of a glycerol concentration (e.g., beyond about 40 wt. %) may result in declines in tensile strength and water resistance.

In some examples, the formulation may comprise a crosslinker or crosslinking agent, such as triethylamine (TEA), ammonium zirconium carbonate (AZC), glyoxal, silicon dioxide nanoparticles, a polyacid (e.g., citric acid), epoxide, boric acid, and/or urea. The crosslinker(s) may serve to add strength and some amount of hydrophobicity to the resulting biodegradable composite 102. AZC used with glyoxal, a bifunctional aldehyde with two reactive ends, may not only crosslink the starch but also improve the water-resistance of the biotextile 100. Glyoxal works to improve hydrophobicity through the formation of interchain covalent bonds with the hydroxyl groups on starch. The addition of glyoxal may also improve the tensile strength and UV resistance of a starch-based biodegradable composite 102. It is contemplated that citric acid may be beneficially used as a crosslinker in place of AZC and glyoxal, with the added benefit of reduced hydrophilicity.

It may be beneficial for the formulation to include a hydrophobic agent such as a fatty acid, a surfactant, an oil, and/or a wax to function as a water barrier. The aliphatic group of these hydrophobic agents can migrate to the surface of the composite to reduce unfavorable interactions with hydrophilic polysaccharides, making the surface more hydrophobic. Exemplary surfactants may include stearyl alcohol ethoxylate and/or glycerol monostearate. The silicon dioxide nanoparticles and the polyacids (e.g., citric acid) described above for crosslinking may also help to reduce the hydrophilicity of the composite; the SiOH groups on the surface of the nanoparticles and the carboxylic acids may react with C—OH of the starch/cellulose.

The formulation may further comprise a liquid or powder dye and/or a pigment, preferably derived from nature. For example, the liquid or powder dye and/or the pigment may be extracted from algae and/or fruit. More specifically, the dye and/or pigment may be derived from or comprise macro or microalgae, a bacterially fermented biosynthetic dye, a yeast fermented biosynthetic dye, a fruit-based dye, and/or another plant-based dye extract. In some examples, the liquid or powder dye and/or the pigment may be derived from a non-petrochemically derived source, such as an inorganic or organometallic species. Mineral-based pigments, such as iron oxide and/or titanium oxide, may be suitable. Dyes derived from natural sources may inhibit or prevent issues that arise from the use of synthetic dyes, including water pollution from dye runoff. The dye may be added directly into the formulation. Accordingly, a dye bath and the associated waste are not required, as in traditional approaches to dyeing leather and other fabrics. The formulation may further comprise a commercially available fragrance that is dispersed through the composite 102. Accordingly, the entire biotextile 100 may have a long-lasting scent. It is also contemplated that the formulation may further include a foaming agent to aid in the texture and “feel” of the biotextile 100.

As indicated above, bacterial nanocellulose, when incorporated into the formulation, may be obtained from commercial sources or grown in-house in the form of SCOBY. In the latter case, the process entails creating the growth media and inoculating it with cultures.

In one example of a suitable growth process, 6 L of water are boiled and 600 g of white sugar and 60 g of black tea are added and allowed to seep for 15 minutes. The tea is then removed and the media is allowed to cool to room temperature. This growth media is moved to sterilized vats, and inoculated by transferring 1 L of exhausted bacterial cultures via peristaltic pump. The cultures are allowed to incubate for 21 days before the first extraction is made. Two subsequent extractions are done 14 days after the previous extraction, i.e., the second extraction is done 14 days from the first extraction and the third is done 14 days after the second extraction, or 28 days from the first extraction. After extractions have been completed, the samples are sterilized and processed. The SCOBY sheets are manually cut into 2×2 squares and treated with 1% NaOH for 20 minutes. Next, they are rinsed with water and placed in boiling water. Addition of the cubes brings the water temperature down to below the boiling point; once the water begins boiling again, boiling is continued for ten minutes. Following the boiling process, the water is drained, and the sheets are treated with disinfectant solution to reduce odor and apply an antifungal. In this example, the disinfectant solution includes 20 mL of OdoBan for 5 L of water. The disinfectant solution is poured over the SCOBY squares for about 20 minutes. The SCOBY squares are blended down into microcrystals using a household style blender, which may then be added to the formulation to prepare the biodegradable composite 102.

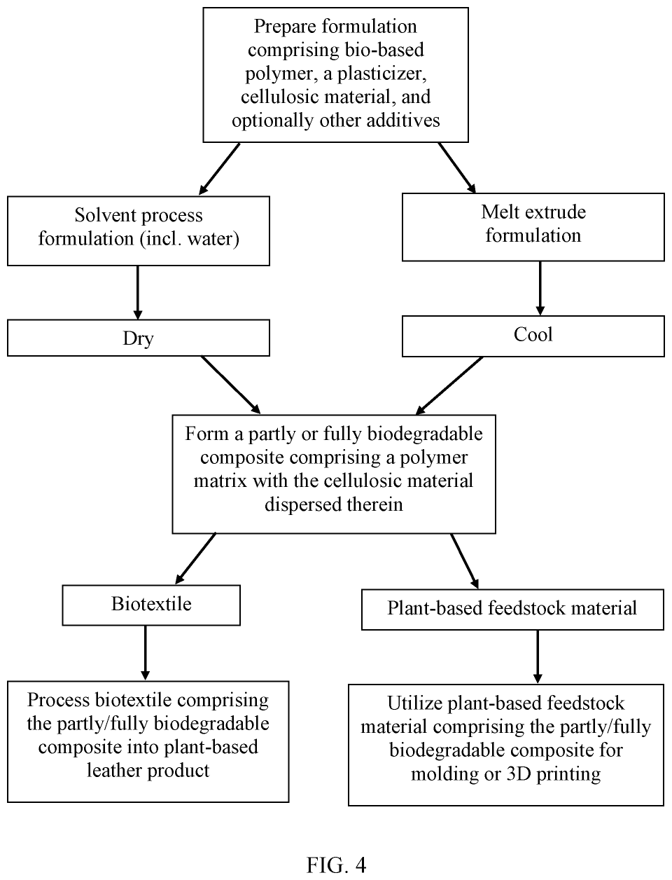

As indicated in FIG. 4, the partially or fully biodegradable composite 102 may be prepared by solvent casting or melt extrusion of the formulation described above. In the former process, solvent casting is followed by drying to form a sheet comprising the composite 102, and in the latter process, melt extrusion is followed by cooling to form the composite 102 having a predetermined shape. Each of these processes is described below. Referring to FIG. 4, a biotextile that may undergo further processing to form a plant-based leather product may comprise the partially or fully biodegradable composite 102, or a plant-based feedstock material that may be utilized as a raw material in molding or 3D printing may comprise the partially or fully biodegradable composite 102.

To carry out melt extrusion, the formulation, which may comprise a bio-based polymer (e.g., starch), a plasticizer, and a cellulosic material (e.g., bacterial cellulose), is heated and mixed to form a molten mixture, and the molten mixture is extruded to form an extruded body having a size and shape (“predetermined shape”) determined by the extrusion die. The predetermined shape may be a sheet, a rod, a pellet, a granule, or another desired shape. Upon cooling of the extruded body, a partially or fully biodegradable composite 102 having the predetermined shape and including a polymer matrix 106 with the cellulosic material 104 dispersed therein is formed. The polymer matrix 106 includes the bio-based polymer, which may be starch in one example, and may include one or more other natural, synthetic or fermented polymers.

Melt extrusion may entail heating and mixing the formulation in an extrusion barrel at a melt temperature in a range from, for example, about 70° C. to about 210° C. This range of temperatures is suitable for the melting temperatures of the ingredients that form/compose the composite without risking thermal decomposition. During mixing, volatile gases and/or water vapor may be removed through a vent in the barrel. The molten mixture is forced through an opening in a die at the end of the barrel to form the extruded body having the predetermined shape. The barrel may include a screw that is rotated at a suitable rotational speed (e.g., from about 100 rpm to about 800 rpm) to force the molten mixture through the opening. The die may be maintained at the melt temperature (e.g., in the range from about 120° C. to about 210° C.) during extrusion. The extruded body is then cooled, for example by immersion in a coolant (e.g., water) bath or by exposure to a flow of coolant (e.g., air), to form the partially or fully biodegradable composite 102 having the predetermined shape. This composite 102 can be produced in the same twin screw extruder where it is compounded or in an additional single screw extruder. By the nature of the extrusion process, there is no fundamental limit on the length of the composite 102 that may be formed by melt extrusion. To fabricate sheets, the width of the extruded composite typically lies in the range from about 2.5 cm to about 173 cm depending on the size of the die, and the thickness of the extruded composite may be in the range from about 0.1 mm to about 3 mm, given the intended biotextile application. A total time duration for melt extrusion may be 3-4 hours, in some examples, or melt extrusion may continue indefinitely in a continuous process.

As an alternative to melt extrusion, the formulation may further include water, and the biotextile 100 may be prepared by solvent casting. More specifically, a formulation comprising a bio-based polymer such as starch, a plasticizer, water, and a cellulosic material such as bacterial cellulose may be solvent cast and dried to form a sheet comprising a partially or fully biodegradable composite 102, where the composite 102 includes a polymer matrix 106 with the cellulosic material 104 dispersed therein. The polymer matrix 106 includes the bio-based polymer, which may be starch, and may include one or more other natural, synthetic or fermented polymers.

The solvent casting may entail pouring the formulation into a tray and drying (e.g., in air) to form the sheet, which may have a predetermined thickness based on the intended biotextile application. For example, the predetermined thickness may lie in a range from about 0.2 mm to about 2 mm. Sheet sizes of up to about 51×76 cm² in area, or greater, may be prepared by solvent casting. The total time for the solvent casting process may range from about 24 hours to multiple days (e.g., 4-6 days). The solvent casting process may be carried out at room temperature, or at a temperature between room temperature (e.g., about 20-25° C.) and 60° C., or between about 40° C. and about 60° C.

Prior to solvent casting, the formulation may be prepared by dissolving and/or suspending the bio-based polymer (e.g., starch) and the plasticizer in the water to form a polymer solution, and mixing in the cellulosic material (e.g., bacterial cellulose). The concentration of the bio-based polymer, plasticizer and cellulosic material in the water may be in a range from about 10% to about 60%. The formulation may be prepared at a temperature in a range from about 50° C. to about 100° C.

As indicated above, a biotextile 100 or a plant-based feedstock material 300 may comprise the partially or fully biodegradable composite 102 prepared as described above.

The biotextile 100 may be further processed into a plant-based leather product 200, e.g., a purse, bag, belt, shoe, apparel item (e.g., jacket, glove, pants), strap, handle, watch band, wallet, dashboard, automotive seat, aerospace textile, bicycle seat textile, upholstery, interior design item (e.g., lampshade, pillow), home goods item (e.g., tea kettle handle, headphone cushion covering), boxing glove, weight training belt, upholstery, pet collar, bath sandal, brush, book binding, book cover, and/or protective coating. The further processing may include, for example, finishing, cutting, patterning, assembling, stitching, skiving, printing, sanding, perforating, embossing, embroidering, thermoforming, melting, and/or gluing.

Advantageously, the biotextile 100 has multiple properties that meet or exceed applicable industrial standards for vinyl or leather. For example, the biotextile 100 may meet the requirements for marine vinyl, which has the same specifications as standard vinyl with more stringent requirements for durability and sun/water damage resistance. The industrial standards for marine vinyl relevant to the biotextile 100 measure durability, water resistance, tensile strength and heat/cold resistance. In regard to durability, the biotextile 100 may exhibit no appreciable color or structural change after 300 or 650 hours, no appreciable wear after 25,000 cycles, and/or no appreciable crazing after 25,000 cycles. In regard to water resistance measured using the hydrostatic head test, the biotextile 100 may achieve a waterproof rating of at least 8,000 mm water entry pressure, or above 10,000 mm water entry pressure. In regard to tensile strength, the biotextile 100 may achieve 50×50 lb using CFFA 17 and 15×15 lb with CFFA 16b or 16c. In regard to heat/cold resistance, the biotextile may not crack while undergoing the CFFA 6a method and/or the biotextile 100 may score 8% while undergoing the CFFA 18 method.

To satisfy the ISO 17186-A standard, the thickness of the biotextile 100 may be from about 1 mm to about 2 mm for materials used for shoes, gloves, and apparel goods applications. Such thicknesses are greater than those of traditional nanocellulose mats (which may have a thickness around 0.3 mm) and can be achieved by solvent casting with a suitable pouring thickness and/or by melt extrusion, as described below.

For leather shoes, gloves, and apparel applications, important mechanical properties include tensile and tear strength. Generally speaking, the composite 102 may exhibit a tensile strength of at least 2.5 N/mm² (MPa), or at least 4 N/mm², and/or as high as 15 N/mm², or as high as 20 N/mm². To meet requirements for chrome tanned upper leather for shoes as established by ISO 20942, the biotextile 100 may exhibit a tensile strength in excess of 5 N/mm², and values as high as 20 N/mm² have been demonstrated. In contrast, nanocellulose mats have a tensile strength of about 9.7 N/mm², which does not meet the criteria for leather shoes.

Flex resistance is also important as the biotextile 100 may undergo convex and concave deformation during use. A flexometer test can be used to measure long term resistance against bending. Grade 0 is the best rating, indicating that the material and any coating layers have no cracks from flexing. The biotextile 100 may exhibit a grade of ≤2 after 80,000 flex cycles, indicating only small cracks in the top coating layer, as required by the ISO 20942 standard for leather shoe and other applications. Using the ISO 32100 method, nanocellulose mats reach only 10,000 cycles before passing a grade of 2. In contrast, using the ISO 5402 Bally Flex Resistance test, the biotextile 100 may exhibit consistent performance with no noticeable damage up to 120,000 cycles.

Water vapor permeability is also an important characteristic of the biotextile 100, as it allows the body's humidity to be transported through the biodegradable composite 102 to the outer surface. For sufficient comfort for wear as required by the ISO 20942 standard, the biotextile 100 may have a water vapor permeability greater than 0.8 mg/(cm²×h) using the ISO 14268 standard testing method. In contrast, nanocellulose mats exhibit an insufficient water vapor permeability of about 0.1 mg/(cm²×h). Additives to the biotextile 100, such as glycerol, may enhance the water permeability, and structural changes may also or alternatively be made, such as incorporating small holes into the biodegradable composite to decrease the fabric tightness. In the example of a woven biotextile 100, the water permeability may be enhanced by increasing yarn twist and decreasing fabric tightness, as increasing free space between woven fibers may provide more breathability.

The biotextile 100 may also or alternatively be resistant to water, sunlight, and/or abrasion. A water-resistant and/or waterproof biotextile 100 may prevent plant-based leather bags, shoes, and other accessories from getting soaked in the rain, for example. Advantageously, the biotextile 100 is hydrophobic, as shown by the lack of wettability of water on the surface. More specifically, when a water droplet is placed on the biotextile surface, it has an initial contact angle in excess of 90°, indicating hydrophobicity. In contrast, untreated nanocellulose mats are observed to be hydrophilic and water absorbent, which is undesirable for textile applications.

Preferably, the biotextile 100 is resistant to ultraviolet (UV) radiation. UV radiation can cause photochemical changes within textiles that result in fading of color and loss of strength. The addition of glyoxal, as discussed below, may contribute to the superior UV resistance of the biotextile 100 in comparison to bacterial cellulose mats, as determined by AATCC 16 testing standards.

The biotextile 100 may also exhibit good abrasion resistance as determined by the Martindale abrasion test, for example. Good abrasion resistance is beneficial since the biotextile 100 may be exposed to friction in use throughout its lifespan. The Martindale test entails rubbing a textile sample with small discs of worsted wool or wire mesh and continually inspecting the sample for wear and tear. The test results are reported as a number of cycles, and the higher the number, the more suitable the textile may be for heavy usage. The biotextile 100 may sustain at least 800 dry cycles with fewer than five damages/breaks and only a slightly roughened surface.

Referring to FIG. 3, a plant-based feedstock material 300 may comprise the partially or fully biodegradable composite 102 fabricated as described above and having a predetermined shape (e.g., an extruded shape), such as a rod 302, pellet 304, or granule 306. The composite 102 of the plant-based feedstock material 300 may have any of the characteristics and/or properties set forth above for the composite 102 that forms the biotextile 100. The plant-based feedstock material 300 may be further processed by molding (e.g., injection molding) or 3D printing to form a plant-based molded or 3D printed part 350, as illustrated in FIG. 3. Accordingly, after fabrication of the partially or fully biodegradable composite 102, typically in the form of one or more rods 302, pellets 304, or granules 306, the plant-based feedstock material 300 may be delivered into a printhead, hopper or mold 320. The molded or 3D printed part 350 may form part or all of a footwear product, an apparel item, a lamp shade, a handle, or another product. For some applications, the molded or 3D printed part 350 may be translucent.

At the end of its lifespan, there are various options for partial or complete biodegradation of the biotextile 100 or any molded or 3D printed part 350 fabricated from the plant-based feedstock material, including industrial composting, backyard composting, and submerging in microbial aqueous media. Industrial settings can accelerate the biodegradation time due to the control industrial compost settings may have on temperature, moisture, airflow, and other factors that can affect bacterial activity. Composting is the process of organic material decomposition. Organic material, microorganisms, air, water, and nitrogen are essential elements and conditions that allow decomposition to occur. Organic materials have varying carbon (C) to nitrogen (N) ratios, which influence how fast microorganisms break them down. The ideal C:N ratio is believed to be about 30:1 for efficient decomposition. The biotextile 100 may be used as organic material in a compost pile.

For a biotextile 100 comprising a partially or fully biodegradable composite 102 produced from PVA-starch blends with glycerol, it is expected that, following the ISO 14855 procedure for industrial composting, about 80% of the biotextile 100 may biodegrade after 45 days. The remaining 35% may comprise PVA or poorly degradable components primarily, as the microorganisms necessary to biodegrade PVA are not naturally present in soil, or the size of the material may prohibit access of the microorganisms to certain parts of the material. PVA may exhibit successful degradation in mixed microbial aqueous media including the ligninolytic enzyme LiP of P. chyrysosporium, through the formation of carbonyl groups and double bonds that increase the macromolecule unsaturation.

### Examples

As described above, the partially or fully biodegradable composite 102 may be prepared from a formulation including a bio-based polymer, a plasticizer, and a cellulosic material. The formulation may undergo solution/solvent processing or melt (e.g., extrusion) processing in order to fabricate a biotextile 100 or a plant-based feedstock material 300 having a particular form factor. Examples of suitable formulations and typical properties (Table 1) of the resulting composites 102 are described below.

TABLE 1
Typical Properties for Biotextiles

| Test | Standard (If Available) | Result | |
|---|---|---|---|
| Tensile Strength | ASTM D412-C | 2.5-4.3 | MPa |
| Elongation at Break | ASTM D412-C | 69-129% | |
| Flex Resistance | ISO 5402 | >400 | k cycles |
| Shore A Hardness | ASTM D2204 | 63-75 | |
| Tear Resistance | ISO 3377 | 2.4-5.4 | N/mm |

Biotextiles having properties within the ranges shown in Table 1 may be obtained from the following exemplary formulations (Tables 2 and 3), which are separated by production method. Table 2 provides the approximate ratios of the material made through extrusion, while Table 3 describes the formulation as prepared in aqueous batches using solution or solvent processing. In some cases, there may be suitable alternatives to the specific constituent as indicated.

TABLE 2
Formulation Overview for Extruded Composites

| | | Approximate |
|---|---|---|
| Component | Sources & Notes | Ratios (Wt. %) |
| Bio-based | Exemplary resin comprises a | 75-80 |
| thermoplastic | starch blended with a polyester | |
| resin | and additives | |
| Crystalline | Bacterial- or plant-based micro- | 0.5-2 |
| cellulose | or nanocrystalline cellulose | |
| Pigment | Bio-based or mineral-based | 0.25-3 |
| Bio-based | | 15-25 |
| propylene glycol | | |

As indicated in Table 2, in one example, the bio-based polymer comprises a thermoplastic resin such as thermoplastic starch (75-80 wt. %), the plasticizer comprises propylene glycol (15-25 wt. %), and the cellulosic material comprises crystalline cellulose (0.5-2 wt. %). One or more pigments, such as a bio-based algae pigment or a mineral-based iron oxide or titanium oxide pigment, may be included as an additive (0.25-3 wt. %).

TABLE 3
Formulation Overview for Solvent Cast Composites

| | | Approximate |
|---|---|---|
| Component | Sources & Notes | Ratios (Wt. %) |
| Bio-based | Exemplary resin comprises a | 60-75 |
| thermoplastic | starch blended with a polyester | |
| resin | and additives | |
| Crystalline | Bacterial- or plant-based micro- | 0.5-2.5 |
| cellulose | or nanocrystalline cellulose | |
| Pigment | Bio-based or mineral-based | 0.25-3 |
| Bio-based | | 4.5-5.5 |
| propylene glycol | | |
| Polyol (Plasticizer) | Powder or aqueous solution form | 18-22 |
| Wax | Soy-based waxes | 0-9 |
| Surfactant(s) | Typically in the form of a fatty | 0.5-1 |
| | acid or alcohol combined with a | |
| | biobased hydrophilic group, such | |
| | as a polyol or a polyether | |

As indicated in Table 3, in another example, the bio-based polymer comprises a thermoplastic resin such as thermoplastic starch (60-75 wt. %), the plasticizer comprises propylene glycol (4.5-5.5 wt. %), and the cellulosic material comprises crystalline cellulose (0.5-2.5 wt. %). Additional additives may include bio-based or mineral pigment(s) (0.25-3 wt. %), a polyol such as sorbitol (18-22 wt. %), wax (0-9 wt. %), and/or a surfactant (0.5-1 wt. %).

### Exemplary Formulations for Extrusion Processing

Various formulations were prepared in the extruder under extrusion conditions as described above. The formulations were judged qualitatively, based primarily on their cohesiveness, softness, flexibility, and hand feel. Further property evaluations may be undertaken in the future. The tables show exemplary mixtures used for different formulations, with ratios given where possible. Components of the formulations are summarized below:
(1) Bio-based polymer or polymer resin selected from the following: bio-based low-density polyethylene (LDPE), polyhydroxyalkanoate (PHA), thermoplastic starch (TPS), and/or poly(butylene succinate) (PBS).
(2) Plasticizer comprising propylene glycol (PG).
(3) Cellulosic material selected from the following: (a) bacterial nanocellulose (fermentation-derived) in the form of a bacterial cellulose slurry in water or in the form of dried and milled bacterial cellulose powder; (b) microcrystalline cellulose (plant-derived); (c) nanocrystalline cellulose (plant-derived).
(4) Pigment(s) selected from an algae-based black pigment and iron oxide pigments in various colors (black, blue, red, etc.)
(5) Optional other additive(s), including: stearyl alcohol ethoxylate (a surfactant), glycerol monostearate (GMS) (a surfactant), and/or carnauba wax (for surface feel and hydrophobicity).

In some cases, combinations or blends of bio-based polymer resins were employed for extrusion development. Table 4 lists exemplary blends, where the ratios represent weight ratios of the primary to secondary resin.

TABLE 4
Ratio of Primary:Secondary Resins Used in Different Formulations

Primary Resins

| | | TPS | LDPE |
|---|---|---|---|
| Secondary | PHA | 90:10-50:50 | 75:25 |
| Resins | PBS | 75:25-50:50 | — |

Table 5 details formulation work that was done with the polymer resins and constituents listed. The data represent the percent of the constituent in the total formulation. Each additive is calculated independently of the rest; i.e., the table does not list any specific formulations. Cellulose refers to the three different sources used, but the data and percentage ranges are the same for all different sources. Regions without numeric ranges are combinations that have not been tested to date.

TABLE 5
Weight Percentage of Constituents in Tested
Formulations, Calculated as % of Total Weight

| | | | TPS/ | TPS/ |
|---|---|---|---|---|
| | | | PBS | PHA |
| | TPS | LDPE | Blend | Blend |
| Cellulose | 0.5-2% | 1-13% | — | 5-10% |
| Mineral Pigment | 0.1-5% | — | — | — |
| Bio-based Pigment | 0.1-5% | — | — | — |
| Wax | 1-3% | — | — | — |
| Bio-based Propylene Glycol | 5-25% | — | 0-25% | 7-18% |
| Alcohol Ethoxylate Surfactant | 2-10% | — | 0-25% | — |
| Surfactant - ester of fatty | 0.2-1% | — | — | — |
| acid and polyol | | | | |

The above-described formulations all yielded cohesive extruded sheets of suitable quality for further development and potential use as a biotextile. Additional tests with other bio-based polymers, including polylactic acid (PLA), PHA, and poly(ethylene furanoate) (PEF) are planned or ongoing, as shown in Table 6. The polymer resins may be used alone or in conjunction with a secondary polymer resin, as indicated. In addition, these polymer resins may be combined with one or more of the constituents and additives described above in the formulation for the partially or fully biodegradable composite.

TABLE 6
Ratio of Primary:Secondary Resins
Planned for Different Formulations

| | | Primary Resins | | |
|---|---|---|---|---|
| | | PLA | PHA | PEF |
| Secondary Resins | PHA | 70:30-50:50 | 90:10-50:50 | TBD |

The subject-matter of the disclosure may also relate, among others, to the following aspects:

A first aspect relates to a biotextile for a plant-based leather product, the biotextile comprising: a composite including: a polymer matrix comprising a bio-based polymer; and a cellulosic material dispersed in the polymer matrix, wherein at least one property of the composite is sufficient to meet an industrial standard for leather or vinyl.

A second aspect relates to the biotextile of the preceding aspect, wherein the composite is partially or fully biodegradable.

A third aspect relates to the biotextile of any preceding aspect, wherein the bio-based polymer comprises a natural polymer, a synthetic polymer, and/or a fermented polymer.

A fourth aspect relates to the biotextile of any preceding aspect, wherein the natural polymer comprises starch.

A fifth aspect relates to the biotextile of any preceding aspect, wherein the starch is plasticized so as to be in the form of thermoplastic starch.

A sixth aspect relates to the biotextile of any preceding aspect, wherein the synthetic polymer comprises polyethylene, polybutylene succinate, polyethylene terephthalate, polylactic acid, poly(ethylene furanoate), and/or polyvinyl alcohol.

A seventh aspect relates to the biotextile of any preceding aspect, wherein the fermented polymer comprises polyhydroxyalkanoate.

An eighth aspect relates to the biotextile of any preceding aspect, wherein the cellulosic material is derived from bacteria, the cellulosic material comprising bacterial cellulose.

A ninth aspect relates to the biotextile of any preceding aspect, wherein the cellulosic material is derived from plants, trees, or algae.

A tenth aspect relates to the biotextile of any preceding aspect, wherein the cellulosic material takes the form of cellulose nanocrystals, cellulose nanofibrils, microcrystalline cellulose, micro fibrillated cellulose, and/or sodium carboxymethyl cellulose (CMC).

An eleventh aspect relates to the biotextile of any preceding aspect, wherein the biodegradable composite is translucent.

A twelfth aspect relates to the biotextile of any preceding aspect, wherein the at least one property is selected from the group consisting of: durability, water resistance, tensile strength, tear resistance, heat/cold resistance, flex resistance, water vapor permeability, water resistance, ultraviolet (UV) radiation resistance, and abrasion resistance.

A thirteenth aspect relates to the biotextile of any preceding aspect, wherein the industrial standard is selected from the group consisting of: ISO 20942, ISO 17186, ISO 32100, ISO 14268, ISO 12947, and AATCC 16.

A fourteenth aspect relates to the biotextile of any preceding aspect, wherein the composite exhibits a tensile strength of at least about 4 N/mm², or at least about 15 N/mm².

A fifteenth aspect relates to the biotextile of any preceding aspect, wherein the cellulosic material is included in the biodegradable composite at a concentration of about 1 wt. % to about 20 wt. %, and/or from about 10 wt. % to about 15 wt. %.

A sixteenth aspect relates to the biotextile of any preceding aspect, wherein the polymer matrix includes starch and polyvinyl alcohol.

A seventeenth aspect relates to the biotextile of any preceding aspect, wherein the polymer matrix comprises a crosslinked polymer matrix.

An eighteenth aspect relates to the biotextile of any preceding aspect, wherein the cellulosic material includes bacterial cellulose with carboxymethylcellulose on surfaces thereof.

A nineteenth aspect relates to the biotextile of any preceding aspect, wherein the composite has a thickness in a range from about 0.5 mm to about 4 mm, or from about 1 mm to about 2 mm.

A twentieth aspect relates to a biotextile for a plant-based leather product, the biotextile comprising: a partially or fully biodegradable composite prepared from a formulation including: a bio-based polymer; a plasticizer; and a cellulosic material.

A twenty-first aspect relates to the biotextile of the preceding aspect, wherein the plasticizer comprises a polyalcohol or polyol.

A twenty-second aspect relates to the biotextile of any preceding aspect, wherein the polyalcohol comprises polyvinyl alcohol (PVA).

A twenty-third aspect relates to the biotextile of any preceding aspect, wherein the plasticizer includes glycerine (glycerol), sorbitol, sorbitan, propylene glycol, and/or a sugar or sugar derivative (e.g., glucose).

A twenty-fourth aspect relates to the biotextile of any preceding aspect, wherein the plasticizer includes glycerol and sorbitol.

A twenty-fifth aspect relates to the biotextile of any preceding aspect, wherein the bio-based polymer has a concentration in the formulation from about 40 wt. % to about 80 wt. %.

A twenty-sixth aspect relates to the biotextile of any preceding aspect, wherein the bio-based polymer comprises a natural polymer, a synthetic polymer, and/or a fermented polymer.

A twenty-seventh aspect relates to the biotextile of any preceding aspect, wherein the natural polymer comprises starch.

A twenty-eighth aspect relates to the biotextile of any preceding aspect, wherein the starch is plasticized so as to be in the form of thermoplastic starch.

A twenty-ninth aspect relates to the biotextile of any preceding aspect, wherein the synthetic polymer comprises polyethylene, polybutylene succinate, polyethylene terephthalate, polylactic acid, poly(ethylene furanoate), and/or polyvinyl alcohol.

A thirtieth aspect relates to the biotextile of any preceding aspect, wherein the fermented polymer comprises polyhydroxyalkanoate.

A thirty-first aspect relates to the biotextile of any preceding aspect, wherein the bio-based polymer comprises a blend of a primary polymer resin and a secondary polymer resin having a weight ratio in a range from 90:10 to about 50:50.

A thirty-second aspect relates to the biotextile of any preceding aspect, wherein the primary polymer resin and the secondary polymer resin are selected from the group consisting of thermoplastic starch (TPS), polyhydroxyalkanoate (PHA), polyethylene (PE), low-density polyethylene (LDPE), poly(butylene succinate) (PBS), polyethylene terephthalate (PET), polylactic acid (PLA), poly(ethylene furanoate) (PEF), and polyvinyl alcohol (PVA).

A thirty-third aspect relates to the biotextile of any preceding aspect, wherein the plasticizer has a concentration in the formulation from about 5 wt. % to about 50 wt. %, from about 5 wt. % to about 25 wt. %, and/or from about 25 wt. % to about 50 wt. %.

A thirty-fourth aspect relates to the biotextile of any preceding aspect, wherein the cellulosic material has a concentration in the formulation from about 1 wt. % to about 20 wt. %, and/or from about 10 wt. % to about 15 wt. %.

A thirty-fifth aspect relates to the biotextile of any preceding aspect, wherein the formulation further comprises a crosslinker selected from the group consisting of: triethylamine (TEA), ammonium zirconium carbonate (AZC), glyoxal, silicon dioxide, a polyacid (e.g., citric acid), epoxide, boric acid, and urea.

A thirty-sixth aspect relates to the biotextile of any preceding aspect, wherein the formulation further comprises a hydrophobic agent selected from the group consisting of: a fatty acid, a surfactant, an oil, and a wax.

A thirty-seventh aspect relates to the biotextile of any preceding aspect, wherein the cellulosic material is derived from bacteria, the cellulosic material comprising bacterial cellulose.

A thirty-eighth aspect relates to the biotextile of any preceding aspect, wherein the cellulosic material is derived from plants, trees, or algae.

A thirty-ninth aspect relates to the biotextile of any preceding aspect, wherein the cellulosic material takes the form of cellulose nanocrystals, cellulose nanofibrils, microcrystalline cellulose, micro fibrillated cellulose, and/or sodium carboxymethyl cellulose (CMC).

A fortieth aspect relates to the biotextile of any preceding aspect, wherein the formulation further comprises a liquid or powder dye and/or a pigment.

A forty-first aspect relates to the biotextile of any preceding aspect, wherein the liquid or powder dye and/or the pigment is derived from a natural source.

A forty-second aspect relates to the biotextile of any preceding aspect, wherein the liquid or powder dye and/or the pigment is derived from macro or microalgae, a bacterially fermented biosynthetic dye, a yeast fermented biosynthetic dye, a fruit-based dye, and/or another plant-based dye extract.

A forty-third aspect relates to the biotextile of any preceding aspect, wherein the liquid or powder dye and/or the pigment is derived from a non-petrochemically derived source.

A forty-fourth aspect relates to the biotextile of any preceding aspect, wherein the liquid or powder dye and/or the pigment is derived from an inorganic or organometallic species.

A forty-fifth aspect relates to the biotextile of any preceding aspect, wherein the formulation further comprises a fragrance.

A forty-sixth aspect relates to the biotextile of any preceding aspect, wherein the formulation further comprises a foaming agent.

A forty-seventh aspect relates to the biotextile of any preceding aspect, wherein the composite is prepared by melt extrusion of the formulation.

A forty-eighth aspect relates to the biotextile of any preceding aspect, wherein the formulation further comprises water, and wherein the composite is prepared by solvent casting of the formulation.

A forty-ninth aspect relates to a plant-based leather product comprising the biotextile of any preceding aspect.

A fiftieth aspect relates to the plant-based leather product of the preceding aspect being selected from the group consisting of: purse, bag, luggage, belt, shoe, apparel item (e.g., jacket, glove, pants), strap, handle, watch band, wallet, dashboard, automotive interior coverings, automotive safety gear, aerospace textile, bicycle seat textile, upholstery, interior design item (e.g., lampshade, pillow, electrical fixture covers), home goods item (e.g., tea kettle handle, headphone cushion covering), boxing glove, weight training belt, upholstery, pet collar, bath sandal, brush, book binding, book cover, exercise equipment, portable electronics cases or covers, and protective coating.

A fifty-first aspect relates to the plant-based leather product of any preceding aspect being translucent.

A fifty-second aspect relates to a method of making a plant-based leather product, the method comprising: processing the biotextile of any preceding aspect to form a purse, bag, luggage, belt, shoe, apparel item (e.g., jacket, glove, pants), strap, handle, watch band, wallet, dashboard, automotive interior coverings, automotive safety gear, aerospace textile, bicycle seat textile, upholstery, interior design item (e.g., lampshade, pillow, electrical fixture covers), home goods item (e.g., tea kettle handle, headphone cushion covering), boxing glove, weight training belt, upholstery, pet collar, bath sandal, brush, book binding, book cover, exercise equipment, portable electronics cases or covers, and/or protective coating.

A fifty-third aspect relates to the preceding method, wherein the processing comprises: finishing, cutting, patterning, assembling, stitching, skiving, printing, sanding, perforating, embossing, embroidering, thermoforming, melting and/or gluing.

A fifty-fourth aspect relates to a plant-based feedstock material for molding or 3D printing, the feedstock material comprising: a partially or fully biodegradable composite having a predetermined shape, the composite comprising: a polymer matrix comprising a bio-based polymer; and a cellulosic material dispersed in the polymer matrix.

A fifty-fifth aspect relates to the plant-based feedstock material of the preceding aspect, wherein the predetermined shape is selected from the group consisting of: rod, pellet, and granule.

A fifty-sixth aspect relates to the plant-based feedstock material of any preceding aspect, wherein the composite is translucent.

A fifty-seventh aspect relates to the plant-based feedstock material of any preceding aspect, wherein the cellulosic material is included in the composite at a concentration of about 1 wt. % to about 20 wt. %, and/or from about 10 wt. % to about 15 wt. %.

A fifty-eighth aspect relates to the plant-based feedstock material of any preceding aspect, wherein the cellulosic material is derived from bacteria, the cellulosic material comprising bacterial cellulose.

A fifty-ninth aspect relates to the plant-based feedstock material of any preceding aspect, wherein the cellulosic material is derived from plants, trees, or algae.

A sixtieth aspect relates to the plant-based feedstock material of any preceding aspect, wherein the cellulosic material takes the form of cellulose nanocrystals, cellulose nanofibrils, microcrystalline cellulose, micro fibrillated cellulose, and/or sodium carboxymethyl cellulose (CMC).

A sixty-first aspect relates to the plant-based feedstock material of any preceding aspect, wherein the bio-based polymer comprises a natural polymer, a synthetic polymer, and/or a fermented polymer.

A sixty-second aspect relates to the plant-based feedstock material of any preceding aspect, wherein the natural polymer comprises starch.

A sixty-third aspect relates to the plant-based feedstock material of any preceding aspect, wherein the starch is plasticized so as to be in the form of thermoplastic starch.

A sixty-fourth aspect relates to the plant-based feedstock material of any preceding aspect, wherein the synthetic polymer comprises polyethylene, polybutylene succinate, polyethylene terephthalate, polylactic acid, poly(ethylene furanoate), and/or polyvinyl alcohol.

A sixty-fifth aspect relates to the plant-based feedstock material of any preceding aspect, wherein the fermented polymer comprises polyhydroxyalkanoate.

A sixty-sixth aspect relates to the plant-based feedstock material of any preceding aspect, wherein the bio-based polymers include starch and polyvinyl alcohol.

A sixty-seventh aspect relates to the plant-based feedstock material of any preceding aspect, wherein the polymer matrix comprises a crosslinked polymer matrix.

A sixty-eighth aspect relates to the plant-based feedstock material of any preceding aspect, wherein the cellulosic material comprises bacterial cellulose with carboxymethylcellulose on surfaces thereof.

A sixty-ninth aspect relates to a plant-based feedstock material for molding or 3D printing, the plant-based feedstock comprising: a composite extruded from a formulation including: a bio-based polymer; a plasticizer; and a cellulosic material.

A seventieth aspect relates to the plant-based feedstock material of any preceding aspect, wherein the composite has a predetermined shape selected from the group consisting of: rod, pellet, and granule.

A seventy-first aspect relates to the plant-based feedstock material any preceding aspect, wherein the plasticizer comprises a polyalcohol or polyol.

A seventy-second aspect relates to the plant-based feedstock material of any preceding aspect, wherein the polyalcohol comprises polyvinyl alcohol (PVA).

A seventy-third aspect relates to the plant-based feedstock material of any preceding aspect, wherein the plasticizer includes glycerine (glycerol), sorbitol, sorbitan, propylene glycol, and/or a sugar alcohol (e.g., maltitol).

A seventy-fourth aspect relates to the plant-based feedstock material of any preceding aspect, wherein the plasticizer includes glycerol and sorbitol.

A seventy-fifth aspect relates to the plant-based feedstock material of any preceding aspect, wherein the bio-based polymer has a concentration in the formulation from about 40 wt. % to about 80 wt. %.

A seventy-sixth aspect relates to the plant-based feedstock material of any preceding aspect, wherein the plasticizer has a concentration in the formulation from about 5 wt. % to about 50 wt. %, from about 5 wt. % to about 25 wt. %, and/or from about 25 wt. % to about 50 wt. %.

A seventy-seventh aspect relates to the plant-based feedstock material of any preceding aspect, wherein the bio-based polymer comprises a natural polymer, a synthetic polymer, and/or a fermented polymer.

A seventy-eighth aspect relates to the plant-based feedstock material of any preceding aspect, wherein the natural polymer comprises starch.

A seventy-ninth aspect relates to the plant-based feedstock material of any preceding aspect, wherein the starch is plasticized so as to be in the form of thermoplastic starch.

An eightieth aspect relates to the plant-based feedstock material of any preceding aspect, wherein the synthetic polymer comprises polyethylene, polybutylene succinate, polyethylene terephthalate, polylactic acid, poly(ethylene furanoate), and/or polyvinyl alcohol.

An eighty-first aspect relates to the plant-based feedstock material of any preceding aspect, wherein the fermented polymer comprises polyhydroxyalkanoate.

An eighty-second aspect relates to the plant-based feedstock material of any preceding aspect, wherein the bio-based polymer comprises a blend of a primary polymer resin and a secondary polymer resin having a weight ratio in a range from 90:10 to about 50:50.

An eighty-third aspect relates to the plant-based feedstock material of any preceding aspect, wherein the primary polymer resin and the secondary polymer resin are selected from the group consisting of thermoplastic starch (TPS), polyhydroxyalkanoate (PHA), polyethylene (PE), low-density polyethylene (LDPE), poly(butylene succinate) (PBS), polyethylene terephthalate (PET), polylactic acid (PLA), poly(ethylene furanoate) (PEF), and polyvinyl alcohol (PVA).

An eighty-fourth aspect relates to the plant-based feedstock material of any preceding aspect, wherein the cellulosic material has a concentration in the formulation from about 1 wt. % to about 20 wt. %, and/or from about 10 wt. % to about 15 wt. %.

An eighty-fifth aspect relates to the plant-based feedstock material of any preceding aspect, wherein the formulation further comprises a crosslinker selected from the group consisting of: triethylamine (TEA), ammonium zirconium carbonate (AZC), glyoxal, silicon dioxide, a polyacid (e.g., citric acid), epoxide, boric acid, and urea.

An eighty-sixth aspect relates to the plant-based feedstock material of any preceding aspect, wherein the formulation further comprises a hydrophobic agent selected from the group consisting of: a fatty acid, a surfactant, an oil, and a wax.

An eighty-seventh aspect relates to the plant-based feedstock material of any preceding aspect, wherein the cellulosic material is derived from bacteria, the cellulosic material comprising bacterial cellulose.

An eighty-eighth aspect relates to the plant-based feedstock material of any preceding aspect, wherein the cellulosic material is derived from plants, trees, or algae.

An eighty-ninth aspect relates to the plant-based feedstock material of any preceding aspect, wherein the cellulosic material takes the form of crystalline cellulose, cellulose nanocrystals, cellulose nanofibrils, microcrystalline cellulose, micro fibrillated cellulose, and/or sodium carboxymethyl cellulose (CMC).

A ninetieth aspect relates to the plant-based feedstock material of any preceding aspect, wherein the formulation further comprises a liquid or powder dye and/or a pigment.

A ninety-first aspect relates to the plant-based feedstock material of any preceding aspect, wherein the liquid or powder dye and/or the pigment is derived from a natural source.

A ninety-second aspect relates to the plant-based feedstock material of any preceding aspect, wherein the liquid or powder dye and/or the pigment is derived from macro or microalgae, a bacterially fermented biosynthetic dye, a yeast fermented biosynthetic dye, a fruit-based dye, and/or another plant-based dye extract.

A ninety-third aspect relates to the plant-based feedstock material of any preceding aspect, wherein the liquid or powder dye and/or the pigment is derived from a non-petrochemically derived source.

A ninety-fourth aspect relates to the plant-based feedstock material of any preceding aspect, wherein the liquid or powder dye and/or the pigment is derived from an inorganic or organometallic species.

A ninety-fifth aspect relates to the plant-based feedstock material of any preceding aspect, wherein the formulation further comprises a fragrance.

A ninety-sixth aspect relates to the plant-based feedstock material of any preceding aspect, wherein the formulation further comprises a foaming agent.

A ninety-seventh aspect relates to the plant-based feedstock material of any preceding aspect, wherein the composite is prepared by melt extrusion of the formulation.

A ninety-eighth aspect relates to a method of making a biotextile or plant-based feedstock material, the method comprising: heating and mixing a formulation comprising bio-based polymer, a plasticizer, and a cellulosic material to form a molten mixture; extruding the molten mixture to form an extruded body having a predetermined shape; and cooling the extruded body to form a partially or fully biodegradable composite having the predetermined shape, the composite including a polymer matrix with the cellulosic material dispersed therein.

A ninety-ninth aspect relates to the method of the preceding aspect, wherein heating and mixing of the formulation takes place in an extruder barrel at a temperature in a range from about 70° C. to about 210° C.

A one-hundredth aspect relates to the method of any preceding aspect, wherein the extruder barrel includes a screw, and wherein the extrusion comprises forcing the molten mixture through a die at an end of the barrel by rotating the screw at a rotational speed from about 100 rpm to about 800 rpm.

A one hundred and first aspect relates to the method of any preceding aspect, wherein the screw is part of a twin-screw system.

A one hundred and second aspect relates to the method of any preceding aspect, wherein the die is maintained at the temperature in the range from about 70° C. to about 210° C. during the extrusion.

A one hundred and third aspect relates to the method of any preceding aspect, wherein, during the heating and mixing, volatile gases and/or water vapor are removed through a vent in the extruder barrel.

A one hundred and fourth aspect relates to the method of any preceding aspect, wherein the polymer matrix comprises the bio-based polymer.

A one hundred and fifth aspect relates to the method of any preceding aspect, wherein the bio-based polymer comprises a natural polymer, a synthetic polymer, and/or a fermented polymer.

A one hundred and sixth aspect relates to the method of any preceding aspect, wherein the natural polymer comprises starch.

A one hundred and seventh aspect relates to the method of any preceding aspect, wherein the starch is plasticized so as to be in the form of thermoplastic starch.

A one hundred and eighth aspect relates to the method of any preceding aspect, wherein the synthetic polymer comprises polyethylene, polybutylene succinate, polyethylene terephthalate, polylactic acid, poly(ethylene furanoate), and/or polyvinyl alcohol.

A one hundred and ninth aspect relates to the method of any preceding aspect, wherein the fermented polymer comprises polyhydroxyalkanoate.

A one hundred and tenth aspect relates to the method of any preceding aspect, wherein the bio-based polymer comprises a blend of a primary polymer resin and a secondary polymer resin having a weight ratio in a range from 90:10 to about 50:50.

A one hundred and eleventh aspect relates to the method of any preceding aspect, wherein the primary polymer resin and the secondary polymer resin are selected from the group consisting of thermoplastic starch (TPS), polyhydroxyalkanoate (PHA), polyethylene (PE), low-density polyethylene (LDPE), poly(butylene succinate) (PBS), polyethylene terephthalate (PET), polylactic acid (PLA), poly(ethylene furanoate) (PEF), and polyvinyl alcohol (PVA).

A one hundred and twelfth aspect relates to the method of any preceding aspect, wherein the predetermined shape comprises a sheet, rod, pellet, or granule.

A one hundred and thirteenth aspect relates to the method of any preceding aspect, wherein a biotextile comprises the composite.

A one hundred and fourteenth aspect relates to the method of any preceding aspect, wherein a plant-based feedstock material comprises the composite.

A one hundred and fifteenth aspect relates to the method of any preceding aspect, further comprising delivering the plant-based feedstock material into a printhead, hopper or mold for further processing into a molded or 3D printed part.

A one hundred and sixteenth aspect relates to the method of any preceding aspect, wherein the molded or 3D printed part is translucent.

A one hundred and seventeenth aspect relates to the method of any preceding aspect, wherein the molded or 3D printed part comprises part or all of a footwear product, lamp shade, upholstery, handle, apparel item, or another product (e.g., as described in this disclosure).

A one hundred and eighteenth aspect relates to a method of making a biotextile, the method comprising: solvent casting a formulation comprising a bio-based polymer, a plasticizer, water, and a cellulosic material into a tray; and drying the formulation to evaporate the water, thereby forming a sheet comprising a partially or fully biodegradable composite, the composite including a polymer matrix with the cellulosic material dispersed therein.

A one hundred and nineteenth aspect relates the preceding method, further comprising preparing the formulation, the preparing comprising: dissolving and/or suspending the bio-based polymer and the plasticizer in the water to form a polymer solution; and mixing the cellulosic material in the polymer solution, thereby preparing the formulation.

A one hundred and twentieth aspect relates to the method of any preceding aspect, wherein the formulation is prepared at a temperature in a range from about 50° C. to about 100° C.

A one hundred and twenty-first aspect relates to the method of any preceding aspect, wherein a concentration of the bio-based polymer, plasticizer and cellulosic material in the water is in a range from about 10% to about 60%.

A one hundred and twenty-second aspect relates to the method of any preceding aspect, wherein the sheet has a predetermined thickness in a range from about 0.2 mm to about 2 mm.

A one hundred and twenty-third aspect relates to the method of any preceding aspect, wherein the polymer matrix comprises the bio-based polymer.

A one hundred and twenty-fourth aspect relates to the method of any preceding aspect, wherein the bio-based polymer comprises a natural polymer, a synthetic polymer, and/or a fermented polymer.

A one hundred and twenty-fifth aspect relates to the method of any preceding aspect, wherein the natural polymer comprises starch.

A one hundred and twenty-sixth aspect relates to the method of any preceding aspect, wherein the starch is plasticized so as to be in the form of thermoplastic starch.

A one hundred and twenty-seventh aspect relates to the method of any preceding aspect, wherein the synthetic polymer comprises polyethylene, polybutylene succinate, polyethylene terephthalate, polylactic acid, poly(ethylene furanoate), and/or polyvinyl alcohol.

A one hundred and twenty-eighth aspect relates to the method of any preceding aspect, wherein the fermented polymer comprises polyhydroxyalkanoate.

A one hundred and twenty-ninth aspect relates to the method of any preceding aspect, wherein the bio-based polymer comprises a blend of a primary polymer resin and a secondary polymer resin having a weight ratio in a range from 90:10 to about 50:50.

A one hundred and thirtieth aspect relates to the method of any preceding aspect, wherein the primary polymer resin and the secondary polymer resin are selected from the group consisting of thermoplastic starch (TPS), polyhydroxyalkanoate (PHA), polyethylene (PE), low-density polyethylene (LDPE), poly(butylene succinate) (PBS), polyethylene terephthalate (PET), polylactic acid (PLA), poly(ethylene furanoate) (PEF), and polyvinyl alcohol (PVA).

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1-110. (canceled)

111. A biotextile for a plant-based leather product, the biotextile comprising:
a composite including:
a polymer matrix comprising a bio-based polymer; and
a cellulosic material dispersed in the polymer matrix,
wherein at least one property of the composite is sufficient to meet an industrial standard for leather or vinyl.

112. The biotextile of claim 111, wherein the bio-based polymer comprises a natural polymer, a synthetic polymer, and/or a fermented polymer.

113. The biotextile of claim 112, wherein the natural polymer comprises starch.

114. The biotextile of claim 111, wherein the cellulosic material is derived from bacteria, the cellulosic material comprising bacterial cellulose.

115. The biotextile of claim 111, wherein the cellulosic material is derived from plants, trees, or algae.

116. The biotextile of claim 111, wherein the composite is translucent.

117. The biotextile of claim 111, wherein the at least one property is selected from the group consisting of: durability, water resistance, tensile strength, tear resistance, heat/cold resistance, flex resistance, water vapor permeability, water resistance, ultraviolet (UV) radiation resistance, and abrasion resistance.

118. The biotextile of claim 111, wherein the cellulosic material is included in the composite at a concentration of about 1 wt. % to about 20 wt. %.

119. The biotextile of claim 111 being prepared from a formulation including: the bio-based polymer; a plasticizer; and the cellulosic material.

120. A plant-based leather product comprising the biotextile of claim 111.

121. A plant-based feedstock material for molding or 3D printing, the plant-based feedstock material comprising:
a partially or fully biodegradable composite having a predetermined shape, the composite comprising:
a polymer matrix comprising a bio-based polymer; and
a cellulosic material dispersed in the polymer matrix.

122. The plant-based feedstock material of claim 121, wherein the predetermined shape is selected from the group consisting of: rod, pellet, and granule.

123. The plant-based feedstock material of claim 121, wherein the composite is translucent.

124. The plant-based feedstock material of claim 121, wherein the cellulosic material is included in the composite at a concentration of about 1 wt. % to about 20 wt. %.

125. The plant-based feedstock material of claim 121, wherein the partially or fully biodegradable composite is extruded from a formulation including: the bio-based polymer; a plasticizer; and the cellulosic material.

126. A method of making a biotextile or plant-based feedstock material, the method comprising:
heating and mixing a formulation comprising bio-based polymer, a plasticizer, and a cellulosic material to form a molten mixture;
extruding the molten mixture to form an extruded body having a predetermined shape; and
cooling the extruded body to form a partially or fully biodegradable composite having the predetermined shape, the composite including a polymer matrix comprising the bio-based polymer with the cellulosic material dispersed therein.

127. The method of claim 126, wherein the predetermined shape comprises a sheet, rod, pellet, or granule.

128. The method of claim 126, wherein a biotextile or a plant-based feedstock material comprises the composite.

129. The method of claim 126, further comprising delivering the plant-based feedstock material into a printhead, hopper or mold for further processing into a molded or 3D printed part.

130. The method of claim 126, wherein the molded or 3D printed part comprises part or all of a footwear product, lamp shade, upholstery, handle, or apparel item.
